(19) United States
(12) Patent Application Publication
(10) Pub. No.: US 2026/0102888 A1
(43) Pub. Date: Apr. 16, 2026

(54) CIRCLIP TOOL

(71) Applicants: ZF Friedrichshafen AG, Friedrichshafen (DE); ZF Wind Power Antwerpen N.V., Lommel (BE)

(72) Inventor: Dominique Moors, Lommel (BE)

(21) Appl. No.: 19/353,655

(22) Filed: Oct. 9, 2025

(30) Foreign Application Priority Data
Oct. 14, 2024 (DE) 10 2024 209 944.9

(51) Int. Cl. B25B 27/20

(52) U.S. Cl. CPC B25B 27/205

(57) ABSTRACT

A circlip tool includes a first actuation lever, a second actuation lever, a first tip, and a second tip. The first tip and the second tip are each configured for insertion into one installation hole in a circlip. The first tip is rigidly secured in the first actuation lever, and the first actuation lever and the second actuation lever are borne so as to be pivotable relative to one another. The circlip tool also includes a cam gear, which has a cam borne so as to be rotatable relative to the first actuation lever and a follower borne so as to be displaceable relative to the first actuation lever. The second tip is borne so as to be displaceable relative to the first actuation lever and is kinematically coupled to the follower. The second actuation lever is connected to the cam in a rotationally engaged manner.

### CROSS REFERENCE TO RELATED APPLICATIONS

This application claims benefit to German Patent Application No. DE 102024209 944.9, filed on October 14, 2024, which is hereby incorporated by reference herein.

### FIELD

The disclosure relates to a circlip tool.

### BACKGROUND

Tools for installing and removing large circlips are available as commercial products. To open and close the circlips, these tools have a spindle mechanism. When used frequently, this spindle mechanism is subject to high levels of wear. Moreover, operating the spindle mechanism is time-consuming.

### SUMMARY

In an embodiment, the present disclosure provides a circlip tool that includes a first actuation lever, a second actuation lever, a first tip, and a second tip. The first tip and the second tip are each configured for insertion into one installation hole in a circlip. The first tip is rigidly secured in the first actuation lever, and the first actuation lever and the second actuation lever are borne so as to be pivotable relative to one another. The circlip tool also includes a cam gear, which has a cam borne so as to be rotatable relative to the first actuation lever and a follower borne so as to be displaceable relative to the first actuation lever. The second tip is borne so as to be displaceable relative to the first actuation lever and is kinematically coupled to the follower. The second actuation lever is connected to the cam in a rotationally engaged manner.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

Fig. 1 shows a circlip tool according to an embodiment of the present disclosure.

### DETAILED DESCRIPTION

Embodiments of the present disclosure provide a circlip tool.

A circlip tool refers to a tool for opening and closing circlips. Circlips are standardized in standards DIN 471 and DIN 472.

To be installed and removed, circlips each have two installation holes. A first tip and a second tip of the circlip tool are each inserted into one installation hole in a circlip that is to be installed or removed. Actuating the circlip tool causes a distance between the first tip and the second tip to change. This also changes a distance between the installation holes. The circlip is thus expanded or contracted.

For actuation purposes, the circlip tool according to the disclosure has a first actuation lever and a second actuation lever. The first tip is rigidly secured in the first actuation lever, i.e., without any relative movement between the first tip and the first actuation lever being possible. Furthermore, the first actuation lever and the second actuation lever are borne so as to be pivotable relative to one another, i.e., rotatable relative to one another by an angle of less than 360°.

The circlip tool is actuated by pivoting the first actuation lever and the second actuation lever relative to one another. In some embodiments, the actuation is accomplished by squeezing the first actuation lever and the second actuation lever together. In doing so, an angle between the first actuation lever and the second actuation lever decreases.

According to the disclosure, a cam gear is used as the mechanism for changing the distance between the first tip and the second tip. A cam gear is an arrangement comprising a cam and a follower. The follower is in contact with a cam surface that extends along a curve. When the cam moves relative to the follower, the follower moves along said surface. In some embodiments, the follower moves along said surface in a sliding or rolling manner. As a result, movement of the cam is translated into movement of the follower.

In the present case, the cam is borne so as to be rotatable relative to the first actuation lever. In particular, the cam may be rotatably borne in the first actuation lever. The follower is borne so as to be displaceable relative to the first actuation lever, i.e., so as to be movable in translation. In some embodiments, the cam can move relative to the first actuation lever with exactly one degree of rotational freedom but no degree of translatory freedom. The follower can move relative to the first actuation lever with exactly one degree of translatory freedom but no degree of rotational freedom. In particular, the follower may be borne so as to be linearly displaceable relative to the first actuation lever, i.e., movable along a straight line.

In some embodiments, the cam gear is configured as a planar cam gear. In this case, the follower is displaceable relative to the first actuation lever in a plane that runs orthogonally to an axis of rotation of the cam. In particular, the cam may be configured as a cam disk, i.e., as a discoid component.

Like the follower, the second tip is also borne so as to be displaceable relative to the first actuation lever. To transfer movement of the follower to the second tip, the second tip is kinematically coupled to the follower.

The second actuation lever is connected to the cam in a rotationally engaged manner. This means that the second actuation lever is coupled to the cam such that pivoting of the second actuation lever relative to the first actuation lever is transmitted to the cam. Therefore, as a result of the second actuation lever pivoting, the cam rotates relative to the first actuation lever. As described above, the follower, and thus also the second tip, is consequently displaced relative to the first actuation lever. Since the first tip is rigidly secured in the first actuation lever, the second tip is displaced relative to the first tip. As a result, a distance between the first tip and the second tip changes such that it is possible to install or remove a circlip in whose installation holes the first tip and second tip are inserted.

Pivoting the actuation lever of the circlip tool according to the disclosure is particularly simple and ergonomic for a fitter. Moreover, the time needed to actuate the circlip tool is reduced. The cam gear used according to the disclosure is robust and highly resistant to wear.

In some embodiments, the circlip tool is developed further by a carriage that is borne so as to be displaceable relative to the first actuation lever. In particular, the carriage may be displaceably secured in the first actuation lever.

In accordance with the development, the second tip and the follower are attached to the carriage. Displacement of the carriage relative to the first actuation lever is thus accompanied by displacement of the second tip and of the follower relative to the first actuation lever. In some embodiments, the second tip is rigidly secured in the carriage, i.e., without any relative movement between the second tip and the carriage being possible.

The follower is configured as a roller that is rotatably borne in the carriage. When the cam rotates relative to the first actuation lever, the roller rolls on the aforementioned surface of the cam. This is accompanied by displacement of the roller relative to the first actuation lever and corresponding displacement of the carriage relative to the first actuation lever.

In an embodiment, a spring is braced between the first actuation lever and the carriage. Owing to the bracing, said spring exerts a spring force on the carriage, this spring force bracing the carriage and thus the follower against the cam.

In an embodiment, the second actuation lever is connected to the cam for conjoint rotation. This means that the second actuation lever and the cam are not rotatable relative to one another. Therefore, whenever the second actuation lever pivots relative to the first actuation lever, this is converted into rotation of the cam relative to the first actuation lever at a corresponding angle of rotation.

Additionally, and/or alternatively, the second actuation lever is rigidly connected to the cam, i.e., without any relative movement between the second actuation lever and the cam being possible. In accordance with the development, the second actuation lever is borne by means of the cam. In particular, the second actuation lever can be borne by means of the cam so as to be pivotable into the first actuation lever.

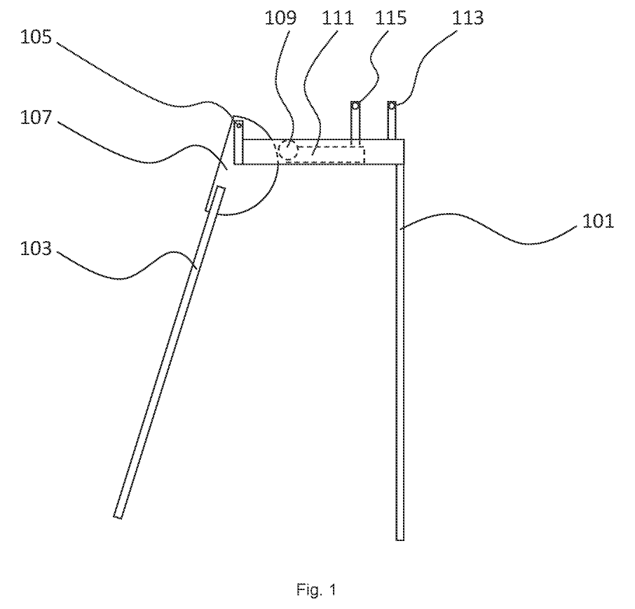

The circlip tool shown in FIG. 1 has a first actuation lever 101 and a second actuation lever 103. The first actuation lever 101 has a bearing 105 by which a cam disk 107 is pivotably borne in the first actuation lever 101.

The second actuation lever 103 is secured in the cam disk 107. As a result, the second actuation lever 103 and the cam disk 107 can be pivoted as one unit relative to the first actuation lever 101. Pivoting the second actuation lever 103 leads to corresponding pivoting of the cam disk 107.

A roller 109 is used as a follower. Said roller is rotatably borne in a carriage 111, which is displaceably attached in the first actuation lever 101. The carriage 111 is spring-loaded. A corresponding spring force acting on the carriage 111 is directed toward the cam disk. As a result, the carriage 111 together with the roller 109 is braced against the cam disk 107, and the roller 109 abuts the cam disk 107. Pivoting of the first lever 101 and the second lever 103 relative to one another, and the accompanying pivoting of the cam disk 107, is thus transferred to the carriage 111 via the roller 109 and leads to the carriage 111 being displaced relative to the first actuation lever 101.

A first tip 113 and a second tip 115 are provided for insertion into the installation holes in a circlip. The first tip 113 is secured in the first actuation lever 101, and the second tip 115 is secured in the carriage 111. Displacement of the carriage 111 owing to the actuation levers 101, 103 pivoting is thus accompanied by the first tip 113 and the second tip 115 being displaced relative to one another.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

101 Actuation lever

103 Actuation lever

105 Bearing

107 Cam disk

109 Roller

111 Carriage

113 Tip

115 Tip

What is claimed is:

1. A circlip tool, comprising:
a first actuation lever, a second actuation lever, a first tip, and a second tip;
the first tip and the second tip each being configured for insertion into one installation hole in a circlip;
the first tip being rigidly secured in the first actuation lever;
the first actuation lever and the second actuation lever being borne so as to be pivotable relative to one another;
a cam gear, which comprises a cam borne so as to be rotatable relative to the first actuation lever and a follower borne so as to be displaceable relative to the first actuation lever;
the second tip being borne so as to be displaceable relative to the first actuation lever and being kinematically coupled to the follower; and
the second actuation lever being connected to the cam in a rotationally engaged manner.

2. The circlip tool according to claim 1, comprising
a carriage borne so as to be displaceable relative to the first actuation lever;
the second tip and the follower being attached to the carriage.

3. The circlip tool according to claim 2, wherein
the follower is configured as a roller that is rotatably borne in the carriage.

4. The circlip tool according to claim 2, comprising
a spring braced between the first actuation lever and the carriage.

5. The circlip tool according to claim 1, wherein
the second actuation lever is connected to the cam for conjoint rotation.

6. The circlip tool according to claim 5, wherein
the second actuation lever is rigidly connected to the cam.
